(19) United States
(12) Patent Application Publication
(10) Pub. No.: US 2025/0115737 A1
(43) Pub. Date: Apr. 10, 2025

(54) ANTIMICROBIAL/ANTIVIRAL RESIN COMPOSITION AND METHOD OF MANUFACTURING THE SAME, AND FOAMED RESIN PRODUCT, FILM PRODUCT, AND FIBER PRODUCT MADE FROM THE RESIN COMPOSITION

(71) Applicant: Shigadry With Earth Co., ltd., Hikone City, Shiga (JP)

(72) Inventor: Hidehiko Tanaka, Hikone City, Shiga (JP)

(73) Assignee: Shigadry With Earth Co., ltd., Hikone City, Shiga (JP)

(21) Appl. No.: 18/566,188

(22) PCT Filed: Sep. 28, 2022
(86) PCT No.: PCT/JP2022/036286

§ 371 Date: Dec. 1, 2023

(51) Int. Cl. C08K 5/098; C08K 3/22; C08L 23/06

(52) U.S. Cl. CPC C08K 5/098; C08K 3/22; C08L 23/06; C08K 2003/2296; C08K 2201/005; C08L 2203/02; C08L 2203/12; C08L 2203/14; C08L 2203/16

(57) ABSTRACT

Problem to be Solved

An antimicrobial/antiviral resin composition maintains high antimicrobial/antiviral activity for a longtime.

Solution to the problem

An antimicrobial/antiviral resin composition is composed of a thermoplastic resin containing at least gluconic acid and zinc gluconate. The thermoplastic resin may further contain zinc oxide. Each of the gluconic acid and the zinc gluconate is in a range of 0.15 to 1.05 parts by mass relative to 100 parts by mass of the thermoplastic resin. The antimicrobial/antiviral resin composition can be used to manufacture foamed resin products, film products, fiber products, etc.

### TECHNICAL FIELD

The present invention relates to an antimicrobial/antiviral resin composition, and more particularly, to a resin composition that maintains antimicrobial/antiviral activity for a long time. The invention also relates to a foamed resin product, a film product, and a fiber product which are made from the resin composition.

### BACKGROUND ART

Since the 2020 COVID-19 pandemic, we have always had to be careful to prevent infection with viruses in our everyday lives.

To prevent these infections, alcohol such as ethanol can be effectively used to sanitize our hands and things we touch. Alcohol, however, has the problem of being unable to inactivate viruses with no envelope such as norovirus, and the problem of volatilizing too quickly without long-lasting effects.

As another sanitizer, hypochlorous acid water is also widely used, but it takes a lot of time to exert a sanitizing effect and cannot perform continuous disinfection or virus inactivation.

The inventor of the present invention has found out that a medicine containing 5000 to 10000 ppm of zinc salt of organic acid has the ability to inactivate avian influenza virus and has suggested the use of this medicine as a virus inactivator (Patent Literature 1). The inventor has also disclosed that the medicine containing this zinc salt of organic acid has an antimicrobial effect not only on viruses but also on various types of bacteria and fungi (Patent Literature 2).

### CITATION LIST

### Patent Literature

PTL 1: Japanese Unexamined Patent Application Publication No. 2010-143875
PTL 2: Japanese Unexamined Patent Application Publication No. 2015-113299

### SUMMARY OF THE INVENTION

### Technical Problem

It is troublesome to disinfect every item by alcohol or other treatment every time someone touches them. Therefore, there is a growing demand for antimicrobial/antiviral-treated products, which have a long-lasting antimicrobial/antiviral effect.

Under such circumstances, an object of the present invention is to provide a safe antimicrobial/antiviral resin composition that has a long-lasting antimicrobial/antiviral effect without any special treatment and that can be used as a material for foamed resin products, film products, fiber products, etc.

### Solution to Problem

To overcome the above-mentioned problems, the antimicrobial/antiviral resin composition of the present invention is composed of a thermoplastic resin containing at least gluconic acid and zinc gluconate.

Among metal ions, mercury (Hg) is said to have the highest bactericidal effect, followed by Ag, Cu, Zn, Fe, and TiO₂ in that order. Since mercury is highly toxic to the environment, silver-based antimicrobial agents are often used instead. Meanwhile, a combined use of gluconic acid and zinc gluconate shows as high antimicrobial properties as silver. Zinc ions are considered to have the same antimicrobial mechanism as silver ions. To be more specific, virus envelopes and bacteria cell membranes are considered to be disrupted not by the toxic or bactericidal properties of the metals but by active oxygen into which some of the oxygen in the air or water are converted by zinc ions.

As shown in Chemical Formula 1, when gluconic acid is dissolved in water, part of this acid is converted to gluconolactone. In this case, gluconic acid and gluconolactone are defined to be in equilibrium. The ratio of the gluconolactone and the gluconic acid differs depending on the temperature, concentration, or pH of the aqueous solution. When acidic, the solution contains a large amount of acid, so that the gluconolactone accounts for a large proportion. Meanwhile, when the solution is alkaline, the gluconic acid is converted to salt and stabilized, so that the gluconolactone accounts for a small proportion. Two components in equilibrium are as if two water tanks that are connected through a tube; when water is poured into the left-side tank, some of the water flows to the right-side tank through the tube to strike a balance.

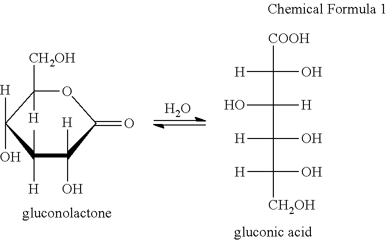

The synergistic effects of the combined use of gluconic acid and zinc gluconate will now be explained in more detail. Viruses have a protein shell called a capsid. As shown in Chemical Formula 2, a protein contains acidic and basic amino acids. When dissolved in water, the acidic amino acid molecules with —COOH are converted to negative ions (COO⁻). Meanwhile, the basic amino acid molecules with —NH₂ are converted to positive ions (—NH₃⁺).

When the positive ions outnumber the negative ions or vice versa in a protein, the protein is dissolved in water. In contrast, when the positive and negative ions are equal in number (they are at the isoelectric point), the protein becomes electrically neutral without charges and remains undissolved in water. When viruses composed of proteins are at their isoelectric point, the viruses become insoluble in water and aggregate with each other. This seems to be how the viruses are inactivated.

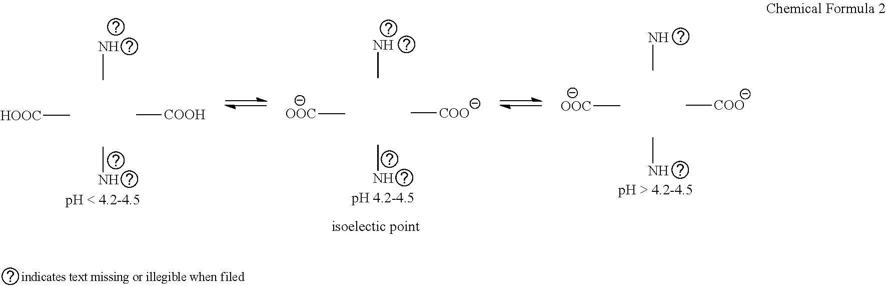

The mixture of the gluconic acid and the zinc gluconate adjusts the isoelectric point of the proteins to make the viruses aggregate and disrupt virus envelopes. This seems to be the reason why the viruses are inactivated.

Such an action also occurs when the resin composition is in contact with moisture in the air or on the surface of the user's hand, allowing the resin composition to exert an antimicrobial/antiviral effect.

Furthermore, zinc gluconate and gluconic acid can be safely added to food and is also safe to the human body.

The term “gluconic acid” used in the present invention includes not only gluconic acid (C₆H₁₂O₇) but also gluconolactone (C₆H₁₀O₆), which is a lactonized form of gluconic acid. Note that the mass of gluconic acid is defined as the mass measured when the gluconic acid and the gluconolactone are all in the form of gluconic acid.

Furthermore, the zinc gluconate may be anhydrate or hydrate (for example, trihydrate). Hydrate is more preferably used. Note that the mass of zinc gluconate is defined in terms of anhydrate.

Also note that the resin composition used in the present invention is not particularly limited in shape or application. For example, the composition can be in the form of a film, a sheet, a plate, a pellet, or a fiber. Furthermore, the composition can be formed into a container, a housing, a foamed resin product, a film product, a fiber product, etc. These resins and resin products can be used for various applications and be applied to various plastic products, chemical fiber products, and the like.

The gluconic acid contained in the antimicrobial/antiviral resin composition has a particle size of preferably 18 mesh or less, more preferably 35 mesh or less, and further more preferably 60 mesh or less. Similarly, the zinc gluconate has a particle size of preferably 18 mesh or less, more preferably 35 mesh or less, and further more preferably 60 mesh or less.

Furthermore, the gluconic acid content of the antimicrobial/antiviral resin composition is preferably 0.15 to 1.05 parts by mass, more preferably 0.2 to 0.9 parts by mass, and further more preferably 0.25 to 0.7 parts by mass relative to 100 parts by mass of the thermoplastic resin.

Similarly, the zinc gluconate content of the resin composition is preferably 0.15 to 1.05 parts by mass, more preferably 0.2 to 0.9 parts by mass, and further more preferably 0.25 to 0.7 parts by mass relative to 100 parts by mass of the thermoplastic resin.

Alternatively, it is possible that the resin composition should contain a mixture of gluconic acid and zinc gluconate preferably 0.3 to 1.2 parts by mass, more preferably 0.35 to 1.0 parts by mass, and further more preferably 0.4 to 0.8 parts by mass relative to 100 parts by mass of the thermoplastic resin.

Furthermore, the thermoplastic resin may further contain zinc oxide particles. In this case, the content of the zinc oxide particles in the resin composition is preferably 0.025 to 0.1 parts by mass, more preferably 0.03 to 0.08 parts by mass, and further more preferably 0.04 to 0.07 parts by mass relative to 100 parts by mass of the thermoplastic resin.

The zinc oxide particles are defined as ultra-fine particles (nanoparticles) with a diameter of 80 nm or less and more preferably 40 to 70 nm. When formed into such nanoparticles, zinc oxide particles have higher antimicrobial/antiviral activity.

The method according to the present invention for manufacturing an antimicrobial/antiviral resin composition in order to solve the above-mentioned problems includes a step of kneading a thermoplastic resin with gluconic acid and zinc gluconate.

This method enables the manufacture of the antimicrobial/antiviral resin composition of the present invention.

The gluconic acid and the zinc gluconate can be prepared from commercially available respective compounds. When a commercially available aqueous compound solution is used, its moisture can be removed before use. Alternatively, gluconic acid and zinc gluconate can be given in the following way.

First, a chemical solution is prepared by dispersing zinc oxide particles (with a size of e.g., 80 nm or less) in a water-based solvent containing gluconic acid to make the zinc oxide particles and the gluconic acid react with each other, thereby converting at least part of the zinc oxide particles into zinc gluconate. Next, the solvent is removed from the chemical solution to produce gluconic acid and zinc gluconate that are to be used in the kneading step.

In this case, the amount (mol) of the gluconic acid is larger than twice and preferably larger than three times the amount (mol) of the zinc, so that a sufficient amount of the gluconic acid is left even after all the zinc oxide particles have been used for reaction. Furthermore, unreacted zinc oxide particles may remain chelated in the chemical solution or in the mixture of the gluconic acid and the zinc gluconate that are to be added to the resin.

When the zinc oxide particles are dispersed in the water-based solvent containing the gluconic acid, some or all of the zinc oxide particles react with the gluconic acid to become zinc gluconate. As a result, the solute of this solution becomes a mixture of gluconic acid and zinc gluconate. The solvent of the solution can be volatilized under normal or reduced pressure, or the solution can be spray-dried to remove the solvent, thereby giving a mixture of gluconic acid and zinc gluconate.

The zinc oxide particles are defined as ultra-fine particles (nanoparticles) with a diameter of 80 nm or less and more preferably 40 to 70 nm. When formed into such nanoparticles, the zinc oxide particles have higher dispersibility in the aqueous solution of gluconic acid and higher reactivity with the gluconic acid.

If some of the zinc oxide nanoparticles are left in the mixture from which the solvent has been removed, the zinc oxide nanoparticles with a large specific surface area contribute to an increase in antimicrobial properties. As another advantage, more of the zinc oxide nanoparticles come into contact with the surfaces of the viruses, thereby inhibiting or inactivating the growth of the viruses.

The kneading step may be performed with the thermoplastic resin heated above its melting point. However, the step is better performed at a temperature lower than the melting point of the thermoplastic resin in order to prevent the resin from reducing the antimicrobial/antiviral effect of the gluconic acid and the zinc gluconate.

If the kneading is performed without melting the resin, the kneading temperature should preferably be 10 to 40° C., more preferably 12 to 35° C., and further more preferably 15 to 30° C. in order to prevent the kneading temperature from adversely affecting the antimicrobial/antiviral effect of the gluconic acid and the zinc gluconate.

On the other hand, if the kneading is performed with a melted resin, due to the same reason, the kneading temperature should preferably be in the range of the melting point of the thermoplastic resin to the melting point plus 30° C., more preferably in the range of the melting point plus 5° C. to the melting point plus 25° C., and further more preferably in the range of the melting point plus 10° C. to the melting point plus 20° C.

The kneading time can be properly determined according to the amount to be manufactured, the surface area and temperature of the pellet, and other conditions. When the kneading is performed without melting the resin, the kneading time is preferably 4 to 48 hours, more preferably 6 to 36 hours, and further more preferably 8 to 24 hours. In contrast, when the kneading is performed with a melted resin, it takes a shorter time.

The thermoplastic resin can be any known thermoplastic resin. Examples of the resin include the following: olefin resins such as polyethylene and polypropylene; general-purpose resins such as polystyrene, polyvinyl chloride, polyvinyl acetate, and acrylic resin; engineering plastics such as polyester, polyamide, polycarbonate, and polyacetal; and super engineering plastics such as polytetrafluoroethylene, polyetheretherketone, and polyphenylenesulfide.

The antimicrobial/antiviral resin composition of the present invention may contain well-known additives such as an antistatic agent, an antioxidant, a thermal stabilizer, an ultraviolet absorber, a flame retardant, a flame retardant auxiliary agent, a coloring agent, a pigment, a light stabilizer, a plasticizer, a tackifier, and a filler, if needed.

Note that adding 1,3-dimethyl-2-imidazolidine to the aqueous solution of zinc gluconate can improve the solubility of the zinc gluconate in water. The 1,3-dimethyl-2-imidazolidine is preferably used because of its nontoxicity.

### Advantageous Effects of Invention

The antimicrobial/antiviral resin composition of the present invention maintains antimicrobial/antiviral activity for a long time.

### DESCRIPTION OF EMBODIMENT

The antimicrobial/antiviral resin composition of the present invention is composed of a thermoplastic resin kneaded with gluconic acid and zinc gluconate.

The zinc gluconate and the gluconic acid properly adjust the isoelectric point of viruses and disrupt virus envelopes to inactivate the viruses.

Commercially available gluconic acid and commercially available zinc measured and contained in the gluconate can be separately antimicrobial/antiviral resin composition.

Alternatively, a mixture of zinc gluconate and gluconic acid which are to be contained in the antimicrobial/antiviral resin composition can be given in the following manner.

First, a chemical solution is prepared as follows. Zinc oxide nanoparticles with a size of 80 nm or less are dispersed and stirred in an aqueous solution of gluconic acid containing 40 to 50 wt % of gluconic acid at room temperature while water is being added so as not to increase the temperature. In this case, the zinc oxide nanoparticles are 5 to 20% by mass of the gluconic acid. It has been confirmed that when the zinc oxide nanoparticles are dispersed in the aqueous solution of gluconic acid, the solution generates heat and undergoes gelation when heated too high. In the prepared chemical solution, all the zinc oxide particles may become zinc gluconate, or some of the particles may remain unreacted.

After the chemical solution is prepared, the moisture is removed by volatilization to produce a medicine component (a mixture containing gluconic acid and zinc gluconate). The volatilization can be performed under reduced or normal pressure. Alternatively, the moisture can be removed by spray drying.

### Example 1

An antimicrobial/antiviral medicine was prepared by adding and stirring 5 g of zinc oxide nanoparticles with a diameter of 50 nm to 70 nm to 100 g of an aqueous solution containing 50% gluconic acid at room temperature while water is being added so as not to increase the temperature. In this case, the added water was 555 g and the total amount of water including the water contained in the aqueous solution of gluconic acid was 605 g.

When this solution was centrifugated, no solid content was found. As a result, the entire amount of the zinc oxide was determined to have become zinc gluconate.

After this, the water in the antimicrobial/antiviral medicine was removed using a constant-temperature dryer (under a normal pressure of 0.1013 MPa), which was kept at 110° C. As a result, a mixture of zinc gluconate (a theoretical value of about 28 g) and gluconic acid (a theoretical value of about 26 g) was produced.

The above mixture was sifted through a sieve of 18 mesh. Then, the mixture and commercially available polyethylene pellets (with a particle size of about 3 mm) were put in a kneader in a mass ratio of 0.6:100 and stirred for 12 hours while the internal temperature was kept at 15 to 30° C. (room temperature). The kneader had a plurality of stirring blades each rotating around the shaft while rotating on its axis. Thus, the antimicrobial/antiviral resin composition of Example 1 was produced.

Note that the zinc gluconate in the mixture was confirmed to contain water of crystallization.

### Example 2

An antimicrobial/antiviral resin composition of Example 2 was produced as in Example 1 except that the mass ratio of the mixture of the zinc gluconate and the gluconic acid, and the polyethylene pellets was 0.4:100.

### Example 3

An antimicrobial/antiviral resin composition of Example 3 was produced as in Example 1 except that 0.3 parts by mass of gluconic acid prepared as below and 0.3 parts by mass of a commercially available zinc gluconate hydrate were added to 100 parts by mass of the polyethylene pellets. The gluconic acid was prepared by heating the commercially available aqueous solution containing 50% gluconic acid to 110° C. to remove moisture.

### Example 4

An antimicrobial/antiviral resin composition of Example 4 was produced as in Example 1 except that the polyethylene pellets and the mixture of the zinc gluconate and the gluconic acid were heated to 140° C., kneaded for 30 minutes, and injection molded in the shape of pellets.

### Antimicrobial Test

Each of the resin compositions (antimicrobial-treated products) of Example 1 to 4 and polyethylene pellets (an antimicrobial-untreated product) were formed into six plates of 50 mm square with a thickness of 2 mm by using an injection molding machine. These six plates made from each product were divided into two groups of three plates each. The three plates in one group were subjected to an antimicrobial test shown below just after they were molded. On the other hand, the remaining three places in the other group were left for 30 days in an atmosphere with a temperature of 25° C. and a humidity of 90%, followed by the same antimicrobial test.

The antimicrobial test was performed in accordance with JIS Z 2801. First, 0.4 mL of bacterial solution (Staphylococcus aureus) was dropped onto a test specimen of 50 mm square (the antimicrobial-untreated product to be compared with Examples) and coated with a film of 4 cm square. The test specimen was cultured for 24 hours in an atmosphere of 35° C. and a relative humidity of 90% or higher. After this, the test bacteria on the test specimen were washed and recovered to measure the viable cell count in 1 cm³. The antimicrobial activity value R was calculated by the following formula:

R=Ut−At
where
Ut represents the average of the logarithm of the viable cell count in 1 cm³ of the antimicrobial-untreated test specimen after the 24 hour-cultivation; and
At represents the average of the logarithm of the viable cell count in 1 cm³ of the antimicrobial-treated test specimen after the 24 hour-cultivation.

TABLE 1

| | | | | Antibacterial activity | |
|---|---|---|---|---|---|
| | | | Amount | value R | |
| | | Way of | of | | 30 days |
| | Temperature | addition | addition | Just after | later |
| Example 1 | Room | Mixture | 0.6 | 3.1 | 3.0 |
| | temperature | | | | |
| Example 2 | Room | Mixture | 0.4 | 2.6 | 2.5 |
| | temperature | | | | |
| Example 3 | Room | Separately | 0.6 | 2.7 | 2.7 |
| | temperature | measured | | | |
| Example 4 | 140° C. | Mixture | 0.6 | 2.4 | 2.3 |

As is clear from these results, the antimicrobial activity values of Example 1 to 4 are 2.3 or higher, indicating high antimicrobial effect. This effect remains the same even after being left for 30 days, indicating that the high antimicrobial effect is maintained for a long time.

Furthermore, the results of Examples 1 and 4 show that the gluconic acid and other compounds can be added to the thermoplastic resin either at room temperature or at as high a temperature as the resin melts. It has also found out that the gluconic acid and other compounds to be added to the thermoplastic resin can be prepared by either of the following methods: separately measuring each compound; and using a mixture of zinc gluconate and gluconic acid obtained by removing the solvent of the chemical solution prepared by adding zinc oxide to an aqueous solution of gluconic acid.

### Application to Products

Antimicrobial/antiviral resin products have been produced in the following manner using the antimicrobial/antiviral resin composition of the present invention.

### Foamed Resin Product

A foamed resin product (a foamed resin container) of the present invention has been produced using the polyethylene pellets of Example 1 and a known pyrolytic chemical foaming agent.

### Film Product

A film product of the present invention has been produced by extruding the polyethylene pellets of Example 1 into film in a known manner.

### Fiber Product

Antimicrobial pellets have been produced using commercially available polyester pellets instead of the polyethylene pellets. The resulting antimicrobial pellets have been melt spun in a known manner and used to produce a fiber product (cloth) of the present invention.

As described above, the antimicrobial/antiviral resin composition of the present invention can be used to produce various resin products having antimicrobial/antiviral properties.

It should be understood that the above Examples have been described as examples of the implementation of the present invention and do not limit the invention. The scope of the present invention is shown not by the above description but by the scope of the claims, including all modifications and equivalents.

For example, melted resin may be kneaded with gluconic acid not into pellets but directly into the shape of a product.

### INDUSTRIAL APPLICABILITY

The antimicrobial/antiviral resin composition of the present invention is made of safe materials that can be used as food additives and also maintains antimicrobial/antiviral effect for a long time. The resin composition can be formed into film products, fiber products, foamed resin products, and the like, providing high industrial applicability.

1.-9. (canceled)

10. An antimicrobial/antiviral resin composition comprising a thermoplastic resin containing at least gluconic acid and zinc gluconate.

11. The antimicrobial/antiviral resin composition according to claim 10, wherein each of the gluconic acid and the zinc gluconate is in a range of 0.15 to 1.05 parts by mass relative to 100 parts by mass of the thermoplastic resin.

12. The antimicrobial/antiviral resin composition according to claim 11, wherein each of the gluconic acid and the zinc gluconate has a particle size of 18 mesh or less.

13. The antimicrobial/antiviral resin composition according to claim 10, wherein the thermoplastic resin further contains zinc oxide.

14. A foamed resin product comprising the antimicrobial/antiviral resin composition according to claim 10.

15. A foamed resin product comprising the antimicrobial/antiviral resin composition according to claim 11.

16. A foamed resin product comprising the antimicrobial/antiviral resin composition according to claim 12.

17. A foamed resin product comprising the antimicrobial/antiviral resin composition according to claim 13.

18. A film product comprising the antimicrobial/antiviral resin composition according claim 10.

19. A film product comprising the antimicrobial/antiviral resin composition according to claim 11.

20. A film product comprising the antimicrobial/antiviral resin composition according to claim 12.

21. A film product comprising the antimicrobial/antiviral resin composition according to claim 13.

22. A fiber product comprising the antimicrobial/antiviral resin composition according to claim 10.

23. A fiber product comprising the antimicrobial/antiviral resin composition according to claim 11.

24. A fiber product comprising the antimicrobial/antiviral resin composition according to claim 12.

25. A fiber product comprising the antimicrobial/antiviral resin composition according to claim 13.

26. A method of manufacturing an antimicrobial/antiviral resin composition, the method comprising kneading a thermoplastic resin with gluconic acid and zinc gluconate.

27. The method according to claim 26, further comprising:
preparing a chemical solution by dispersing zinc oxide particles with a size of 80 nm or less in a water-based solvent containing gluconic acid so as to make the zinc oxide particles and the gluconic acid react with each other, thereby converting at least part of the zinc oxide particles into zinc gluconate; and
removing the water-based solvent from the chemical solution so as to produce the gluconic acid and the zinc gluconate to be used in the kneading step,
wherein the kneading step is performed at a temperature lower than a melting point of the thermoplastic resin.
